(19) United States
(12) Patent Application Publication
(10) Pub. No.: US 2002/0083449 A1
(43) Pub. Date: Jun. 27, 2002

(54) Composition method of on-screen display, menu and remote controller for digtial television

(76) Inventor: So-Young Im, Suwon-city (KR)

Correspondence Address: Robert E. Bushnell, Suite 300, 1522 K Street, N.W., Washington, DC, 20005-1202, US

(21) Appl. No.: 09/956,239

(22) Filed: Sep. 20, 2001

(30) Foreign Application Priority Data
Sep. 20, 2000 (KR) 55129/2000

(51) Int. Cl. H04N 5/445; G06F 13/00

(52) U.S. Cl. 725/39

(57) ABSTRACT

A television on-screen display (OSD) method, the OSD incorporating integration of analog and digital menus, and the use of a remote controller configured to control the television OSD. The method of OSD provides the method for displaying a channel banner, a program information banner, and an electronic program guide (EPG) with proper information, in the adequate space and time. And the remote controller includes left and right direction buttons for scrolling pages of the EPG and moving a cursor in the OSD for selecting certain displayed items; and a select button for executing a function for the currently selected field.

### CLAIM OF PRIORITY

This application makes reference to, incorporates the same herein, and claims all benefits accruing under 35 U.S.C §119 from an application entitled The Composition Method Of On-Screen Display, Menu, And Remote Controller For Digital Television earlier filed in the Korean Industrial Property Office on Sep. 20, 2000, and there duly assigned Ser. No. 2000-55129 by that Office.

### BACKGROUND OF THE INVENTION

1. Field of the Invention

The present invention relates to on-screen display (OSD) method, menu system, and remote controller for digital television.

2. Description of Related Art

Typically, the program information of the analog television broadcasting is provided through a newspaper, a magazine, or a program guide of television. However, as digital multi-channel broadcasting has been introduced, tens to hundreds of channels are provided, and thus the choice of programs becomes more complicated. Therefore, the digital multi-channel broadcasting provides an electronic program guide (hereinafter referred to as simply “EPG”) which shows a program table and other information. In the conventional digital television, the information is displayed as on-screen display (hereinafter referred to as simply “OSD”).

In order to use such EPGs, the conventional remote controller has various functional buttons, a power button, a TV/VTR converter button, a MUTE button, a MENU button, etc. FIG. 1 is a plan view illustrating the conventional remote controller. As shown in FIG. 1, the remote controller has a jog shuttle button 1, up/down channel buttons 2a and 2b, and −/+ volume control buttons 3a and 3b, and others.

The method of OSD described above has the following disadvantages. Worst, the displayed information has too many items and some of them are unnecessary. Besides, the items in one display screen are repeated in another display screen. Accordingly, I desire to simplify the displayed information.

Second, menu items that have no relation with EPG are displayed, e.g., a search menu, which does not operate on the EPG, is activated and it is an obvious functional fallacy. Moreover, the channels are not scrolled by page but by only row, so that information about tens to hundreds of channels is not rapidly provided to the user. Also, for a brilliant appearance of screen, the use of images such as heart-shaped image which represents favorite channel and color button images increases the program size. So the displaying time becomes long and the OSD is not displayed smoothly.

Third, in case of the timeline EPG, the various menus displayed simultaneously occupy so much space, that the information for only five programs may be provided in one page. Further, scrolling by page according to channel and time can not be accomplished.

The conventional remote controller has the following disadvantages in connection with the problems of the OSD method described above. First, there are many buttons not often used, so users become confused. Additionally, the manufacturing cost is high and the size of program becomes large.

Second, the arrangement of upward and downward and left and right buttons on the conventional remote controller is different from the picture structure that is provided as a help function by Multimedia and Hypermedia Information Coding Experts Group (MHEG) broadcasting service. Therefore, when performing the function required for the MHEG service, the user should use the jog shuttle button 1 to move up and down or left and right, usually, however, the user is apt to use channel buttons 2a and 2b or volume control buttons 3a and 3b according to the MHEG service screen, so that there is a room of error such as channel or volume change.

Third, the button name for program information is “DISPLAY”, and the button name for channel navigation is “INFO”. However, the user can't easily understand the use of them at once.

Fourth, in the digital OSD, the items are selected by moving the jog shuttle 1 up and down or left and right direction and executed by pressing the jog shuttle 1. However, it is very difficult and inconvenient to manipulate the jog shuttle as compared with other rubber buttons.

Fifth, in the analog menu, the channel buttons 2a and 2b and the volume control buttons 3a and 3b play a role of moving up and down and left and right, respectively. In the digital menu, however, they do not operate and the jog shuttle 1 replaces the function. In this manner, the methods for manipulating a remote controller in analog and digital mode are not consistent. And the analog menu can be entered directly by using a menu hot key, but the digital menu can be entered only through the EPG.

The problems of the OSD method and the remote controller described above are caused by being designed without mutual correlation. Therefore, the OSD method and the remote controller need to be redesigned with mutual correlation.

Besides, it is preferable to manage the menu items that have no relation with EPG to be separated from EPG. Therefore, it is required to redesign and manage the analog and digital menus systematically and efficiently.

There are numerous patents on electronic program guides and remote controllers therefor. Incorporated by reference are U.S. Pat. No. 6,020,930 to Ludovic Legrand entitled Method and Apparatus for Generating and Displaying a Broadcast System Program Guide; U.S. Pat. No.: 5,986,650 to Michael Dean Ellis et al. entitled Electronic Television Program Guide Schedule System and Method with Scan Feature; and U.S. Pat. No.: 6,177,931 to Ronald Alexander et al. entitled Systems and Methods for Displaying and Recording Control Interface with Television Programs, Video, Advertising Information and Program Scheduling Information.

### SUMMARY OF THE INVENTION

To overcome the problems described above, the preferred embodiments of the present invention provide useful OSD methods and a remote controller that can be easily manipulated by users.

It is another object of the present invention to provide an OSD method and a remote controller that can simplify the process of OSD, decrease the size of a program and provide more improved functions.

It is further object of the present invention to provide a systematic integration of analog and digital menus.

In order to achieve the above objects, the preferred embodiments of the present invention provide an OSD method, including: moving to the upper and lower items of the menu, respectively, using upward and downward direction buttons; and moving to the left and right items of the menu, respectively, using left and right direction buttons.

The preferred embodiment of the present invention provides an OSD method, including: enabling a channel banner to be displayed on the upper and left side of a television screen for a predetermined time and then it disappears; arranging a program information banner on the lower portion of television screen, horizontally; configuring an EPG to occupy the whole screen to help users see a lot of information at once; executing page scroll using color buttons according to channel and time; showing the program information according to each category by pressing a CAT button; and composing the contents of OSD based on text, whereby the size of the OSD program and operating time will be reduced.

The preferred embodiment of the present invention provides an OSD method, including: unifying the main menus in analog mode with ones in digital mode; arranging the sub-menu items in each main menu portion; and providing additional advanced functions.

The preferred embodiment of the present invention further provides a remote controller designed to correspond to a television OSD, including: left and right direction buttons for moving to left and right fields, respectively; upward and downward direction buttons for moving to upper and lower fields, respectively; and a select button for executing the function that the user currently wants. And the remote controller provides additional buttons for selecting e-mail, home shopping, home banking, and internet access functions; a MENU button for selecting the integrated analog and digital menu; a GUIDE button for EPG; an INFO button showing the program information banner; and an EXIT button for ending an application or OSD.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a plan view illustrating the conventional remote control;

FIG. 2 is a plan view illustrating a remote controller according to the preferred embodiment of the present invention;

FIG. 3 shows a channel banner of a television OSD according to the preferred embodiment of the present invention;

FIG. 4 shows a program information banner which is popped up when the user presses the INFO button while watching television according to the preferred embodiment of the present invention;

FIG. 5 shows a detailed program information banner about the program when the user presses the INFO button while the program information banner is displayed according to the preferred embodiment of the present invention;

FIGS. 6 to 8 show an EPG of the television OSD according to the preferred embodiment of the present invention;

FIG. 9 shows the integrated analog and digital menu according to the preferred embodiment of the present invention;

FIG. 10 shows the sub-menu items in the “Program” menu of an analog mode according to the preferred embodiment of the present invention;

FIGS. 11 to 14 show the same sub-menu items of analog and digital modes according to the preferred embodiment of the present invention;

FIG. 15 shows the sub-menu items in a “Setup” menu of an analog mode according to the preferred embodiment of the present invention;

FIG. 16 shows the sub-menu items in the “Program” menu of a digital mode according to the preferred embodiment of the present invention;

FIG. 17 shows the sub-menu items in a “Setup” menu of a digital mode according to the preferred embodiment of the present invention;

FIG. 18 is a flow chart illustrating the display method for a channel banner and a program information banner according to the preferred embodiment of the present invention; and

FIG. 19 is a flow chart illustrating the display method for EPG according to the preferred embodiment of the present invention.

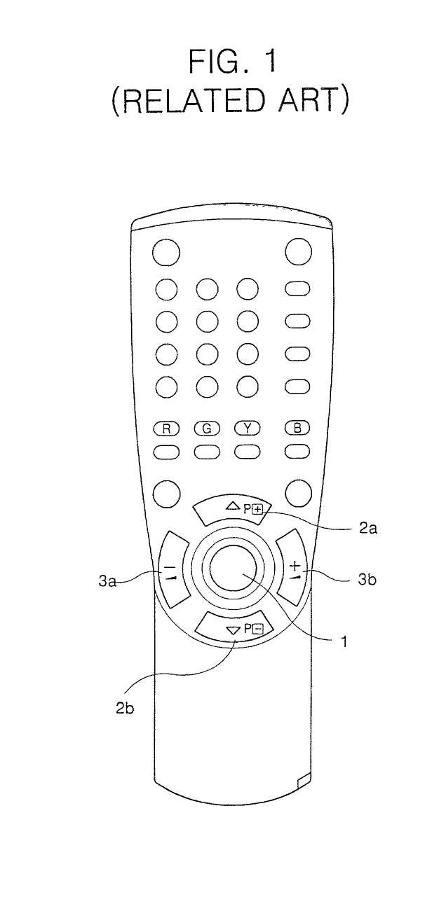

### DETAILED DESCRIPTION OF PREFERRED EMBODIMENTS

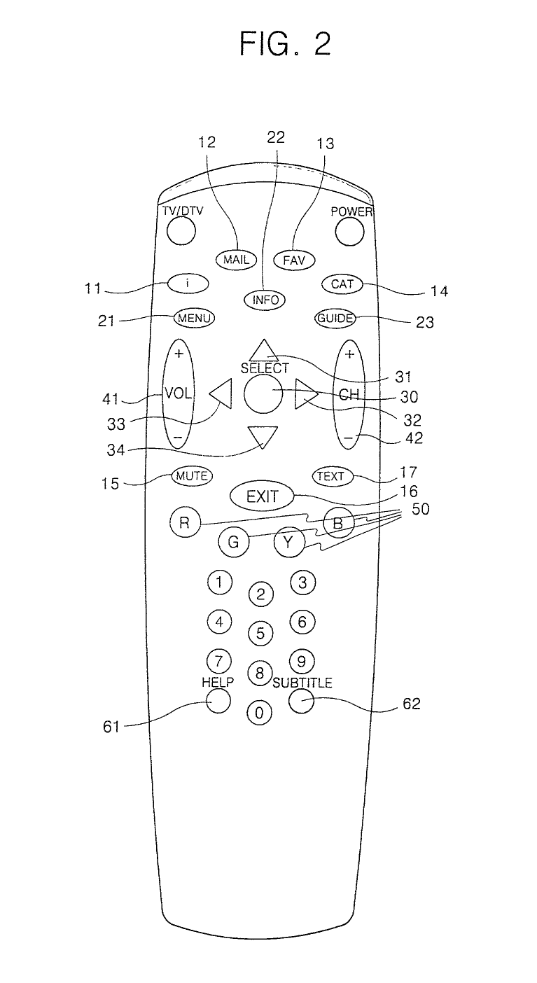

FIG. 2 is a plan view illustrating the remote controller according to the preferred embodiment of the present invention. As shown in FIG. 2, the remote controller has an “i” button 11, a MAIL button 12, a FAV button 13, a CAT button 14, a MUTE button 15, an EXIT button 16, a TEXT button 17, a MENU button 21, an INFO button 22, a GUIDE button 23, a SELECT button 30, direction buttons 31, 32, 33 and 34, a VOL button 41, a CH button 42, color buttons 50, a HELP button 61, and a SUBTITLE button 62, and others.

The “i” button 11 is used to display the functions, such as home shopping, home banking, and internet access. The MAIL button 12 is used to enter an e-mailing function. The FAV button 13 is used to select the favorite channels on an EPG (electronic program guide) and search them on the program information banner. The CAT button 14 functions as a hot button to see programs according to category on the EPG. The MUTE button 15 is used to silence the audio. The EXIT button 16 is used to end an ongoing application program or OSD.

The TEXT button 17 is used to enter an analog text mode. The MENU button 21 is used to display the integrated analog and digital menu. The INFO button 22 is used to see the program information. The GUIDE button 23 is used to see the EPG. The SELECT button 30 is used to execute the function of a selected field. The direction buttons 31, 32, 33 and 34 are used to move up, down, left or right on the OSD screen.

The VOL button 41 is used to control the volume. The CH button 42 is used to increase or decrease channels. The color buttons 50 are composed of four buttons: a red (R) button; a green (G) button; a yellow (Y) button; and a blue (B) button, and they function as the colored items on the OSD. The HELP button 61 is used to see help functions for each menu and OSD. Finally, the SUBTITLE button 62 is used to turn a subtitle on or off.

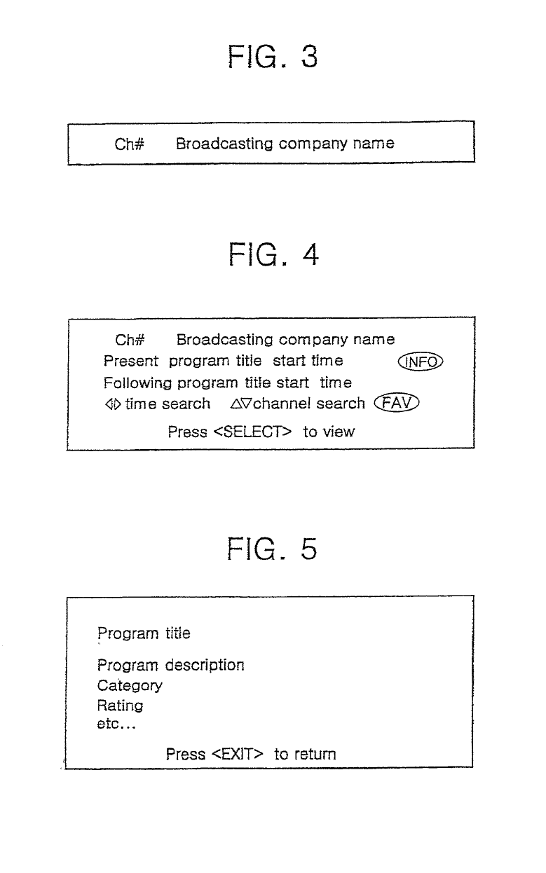

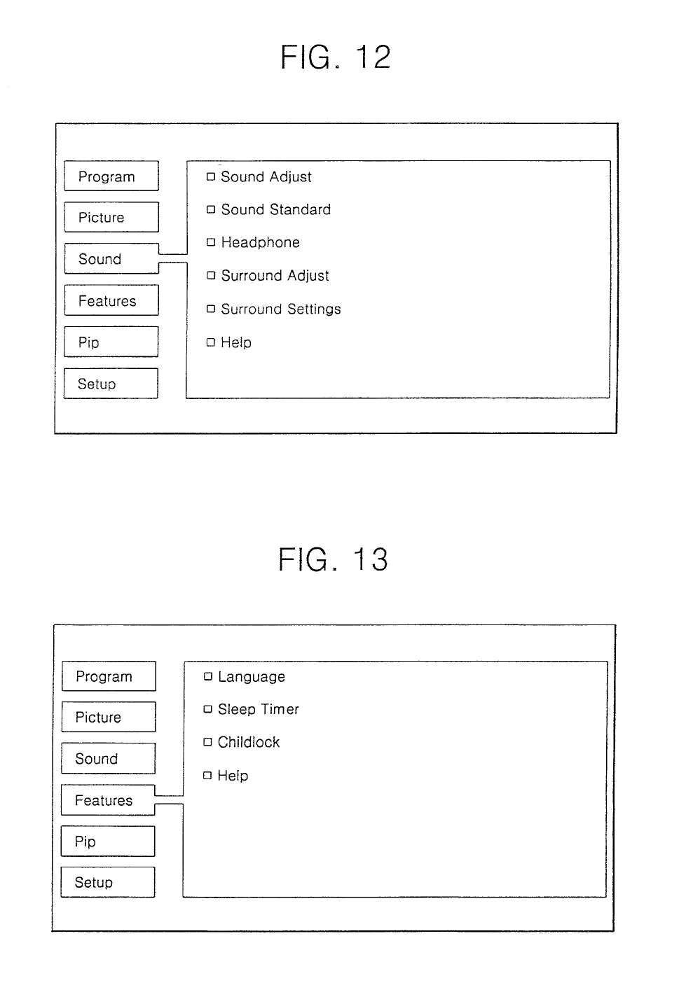

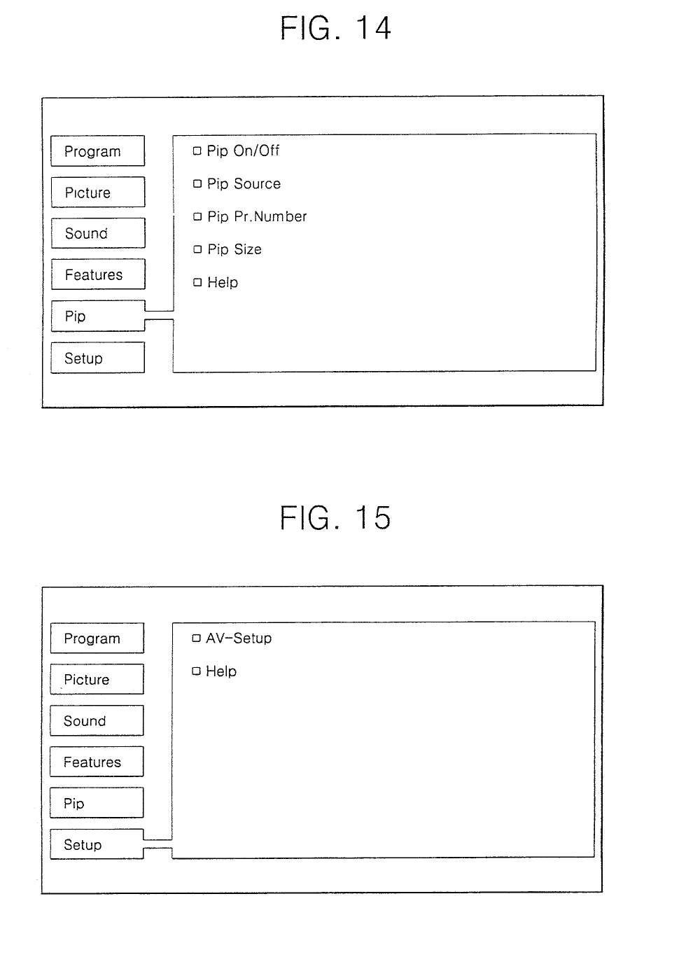

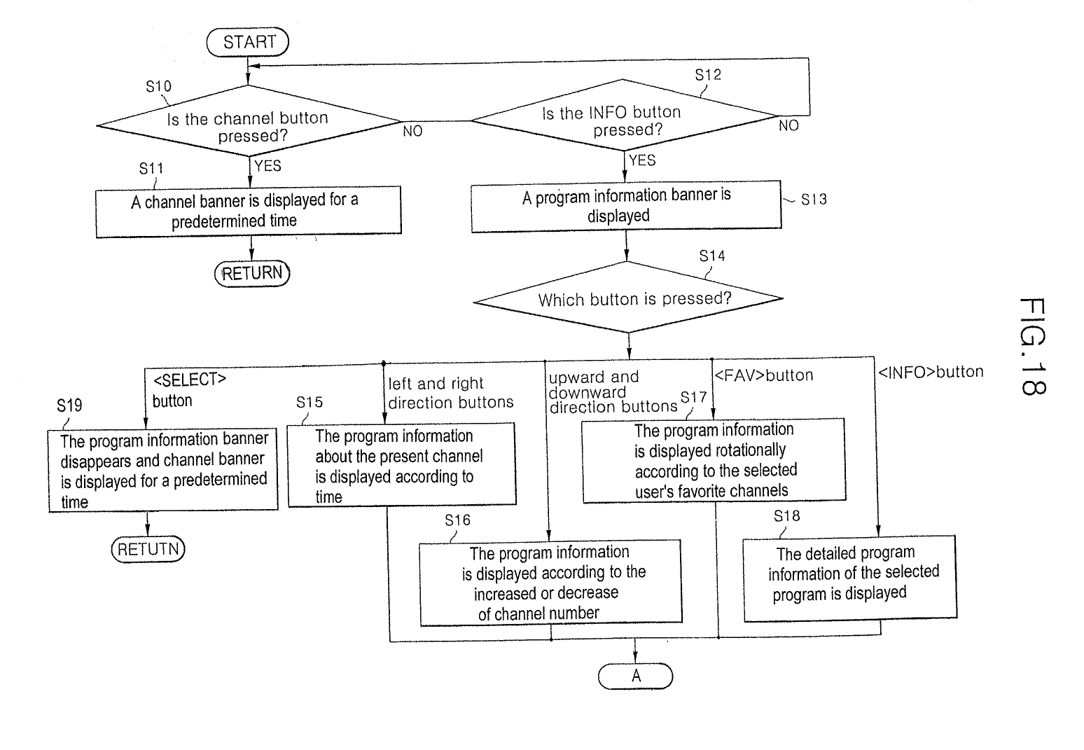

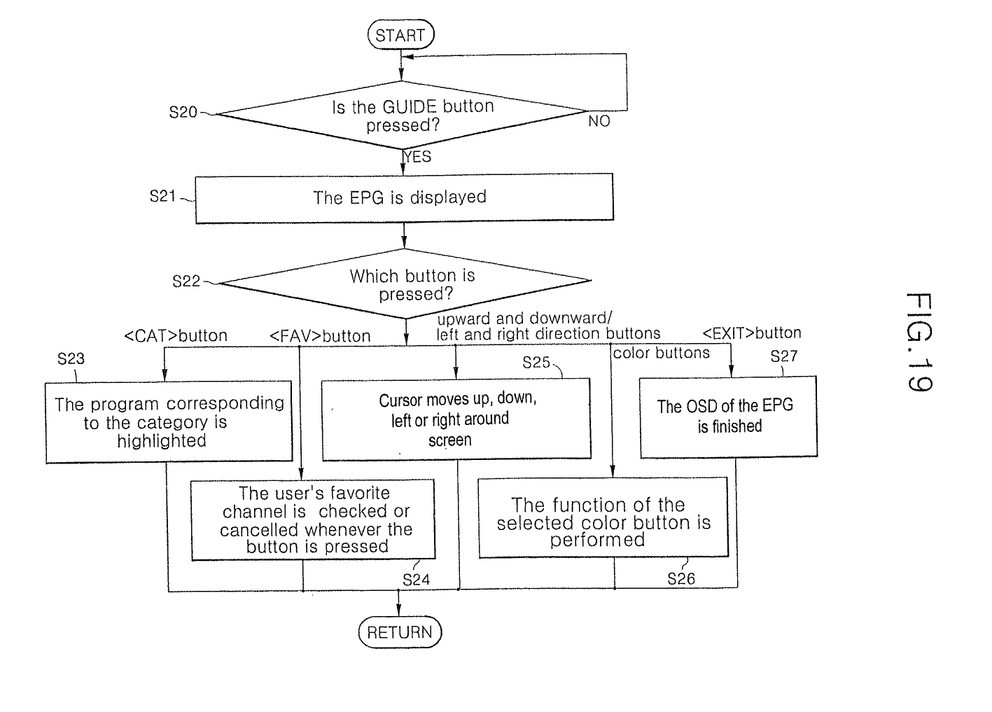

Hereinafter, the configuration of the OSD according to the preferred embodiment of the present invention is explained in detail with reference FIGS. 3 to 19.

FIGS. 3 to 5 and FIG. 18 show the method of OSD for a channel banner and a program information banner according to the preferred embodiment of the present invention. First, if the channel button is pressed while the user is watching television (step S10), the channel banner which contains channel number and broadcasting company name is displayed for a predetermined time period (about two or three seconds), as shown in FIG. 3 and then disappears (step S11). It is preferred, but not limited thereto, that the channel banner be displayed on the upper and left side of a television screen.

If the user presses the INFO button 22, instead of the channel button, while the user is watching television (step S12), the program information banner is displayed, as shown in FIG. 4, (step S13), showing current channel information, present program information and information about the next program. It is preferred, but not limited thereto, that the program information banner be displayed at a different location of the television screen from the location of the channel banner. In this case, the program information banner is displayed on a lower portion of the television screen, across the width of the television screen.

While the program information banner is displayed, if the user presses the left direction button 33 or the right direction button 34, the program information about the present channel is shown according to time (step S15). Here, it is preferred, but not limited thereto, that the time be scrolled in half-hour increments. Also, when the user presses the upward direction button 31 or the downward direction button 32, the program information is displayed according to the increase or decrease of channel number (step S16).

When the user presses the FAV button 13 during display of the program information banner, the program information according to the selected user's favorite channels is rotationally displayed (step S17). The user's favorite channels are easily set on the proposed EPG. When the user presses the INFO button 22 while the program information banner is being displayed, the detailed program information banner, FIG. 5, is displayed (step S18) until the EXIT button is pressed. When the Exit button is pressed while the detailed program information banner is being displayed, the detailed program information banner disappears and the program information banner, FIG. 4, is displayed.

When the user presses the SELECT button 30 (step S19) to watch a certain program selected by any of steps S15-S17, the program information banner disappears, the channel changes (if changed) and the channel banner, FIG. 3, is displayed for a predetermined time.

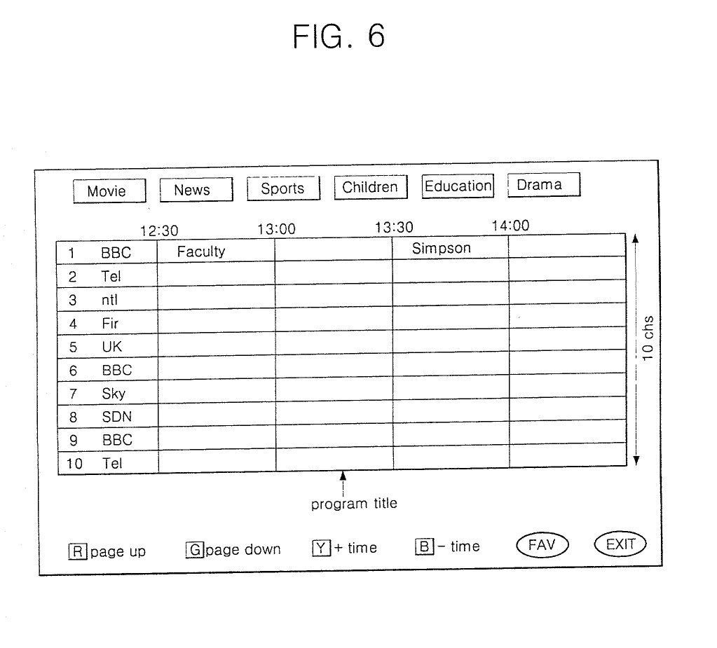

FIGS. 6 to 8 and FIG. 19 show the method of displaying the EPG. When the user presses the GUIDE button 23 (step S20), the EPG, as shown in FIG. 6, is displayed (step S21). Then, the next step is the recognition of which button is next pressed (step S22).

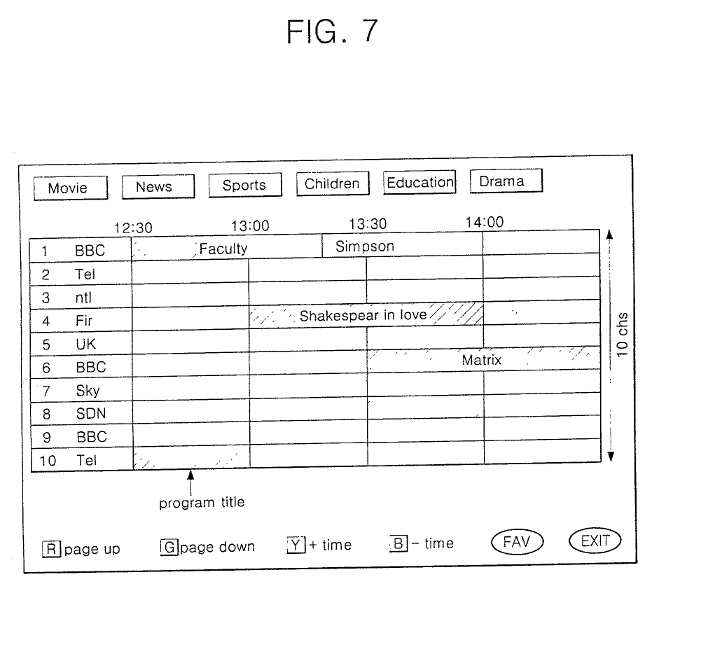

At this time, if the user presses the CAT button 14 (step S23), the program information about the selected category is highlighted. FIG. 7 shows an example of each of the movie items being highlighted.

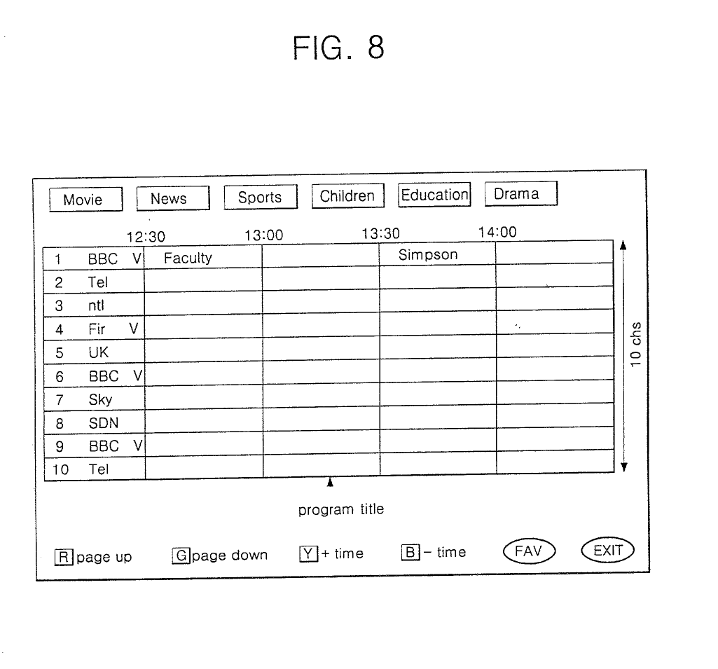

When the user presses the FAV button 13 at step S22, the user's favorite channel is checked or cancelled whenever the button is pressed (step S24). The result performed above is displayed as shown in FIG. 8 when the user checks the channels 1, 4, 6 and 9 as the favorite channels. That is, the channels 1, 4, 6 and 9 are set on the EPG as the favorite channels. Accordingly, if the user presses the INFO button 22 to display the program information banner while watching television, and then presses the FAV button 13, they can rotationally receive the program information about their favorite channels, 1, 4, 6, and 9.

If the user presses the direction buttons 31, 32, 33 and 34 at the step S22, a cursor is moved around the screen according to the selected direction (step S25). Movement is made in steps, by one item, each time the direction button is pressed.

If the user presses the color buttons 50 at the step S22, a sub-function of the selected button is performed (step S26). That is, the color buttons 50 have a main function of controlling displayed color and particular sub-functions (page up, page down, +time and −time) assigned thereto to be performed when the EPG is displayed. While the EPG is displayed, “page up” is executed by pressing the red button R, and “page down” is executed by pressing the green button G, and “+time” is executed by pressing the yellow button Y, and “−time” is executed by pressing the blue button B, as shown in FIGS. 6 to 8.

If the user presses the EXIT button 16 at the step S22, the EPG is finished (step S27).

Because the import of an image is not always understood with the same meaning by people and the viewers are more familiar with text information than image, the OSD information described above is based on text. Besides, this method reduces the program size and OSD display time.

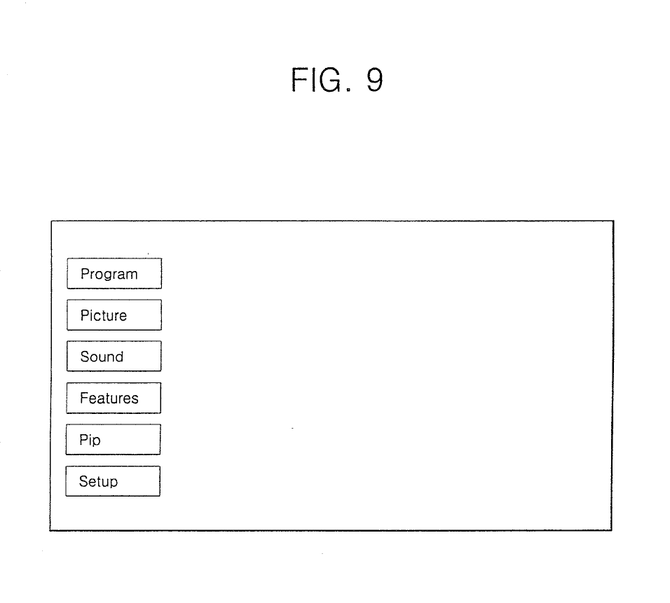

FIGS. 9 to 17 show the method of OSD for the integrated analog and digital menu.

In order to manage the menu items in the same way, the main menus for analog and digital modes are unified. As shown in FIG. 9, the preferred embodiment of the present invention configures six items as a main menu: Program; Picture; Sound; Features; Pip (Picture-in-Picture); and Setup.

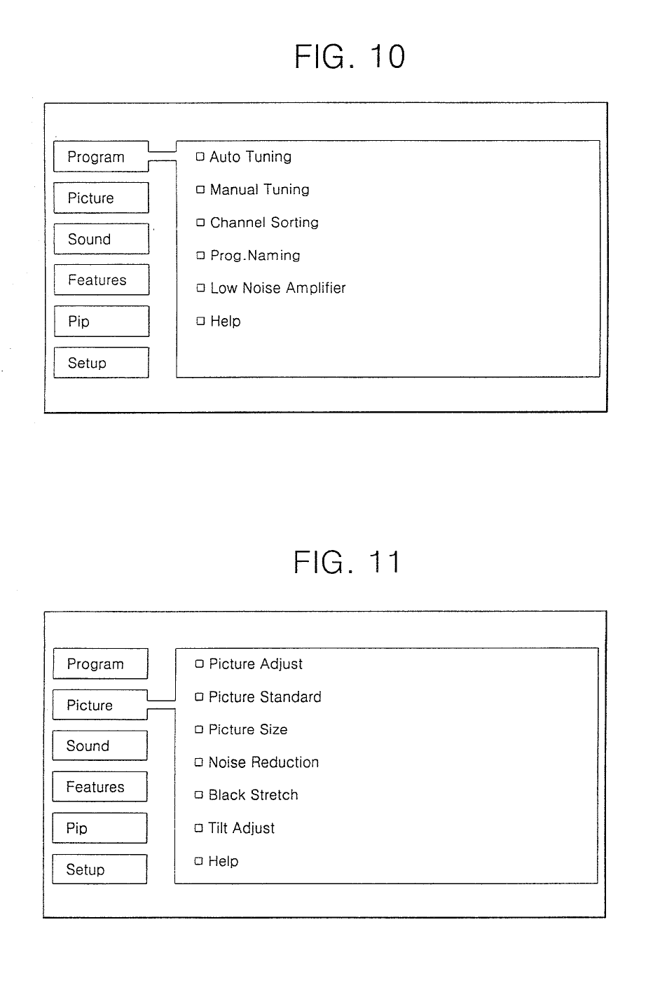

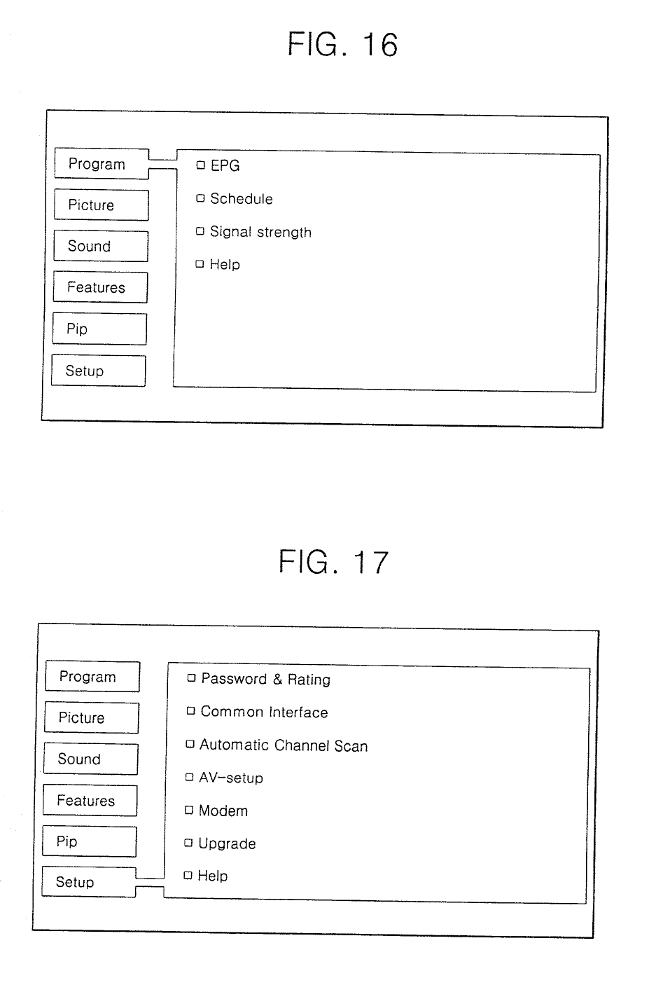

The sub-menu items assigned to the “Picture”, “Sound”, “Features” and “Pip” menus, that are common in both the analog and digital modes, are shown in FIGS. 11 to 14. The sub-menu items assigned to the “Program” and “Setup” menus in the analog mode are shown in FIGS. 10 and 15. And the sub-menu items assigned to the “Program” and “Setup” menus in the digital mode are shown in FIGS. 16 and 17.

In this regard, when a user presses menu button 21 the main menu, FIG. 9, is displayed. One of the six items displayed in the main menu can be selected by moving the cursor using the direction buttons 31 or 34 and then a sub-menu of the selected item is displayed in response to user activation of the select button 30. When a sub-menu is displayed, one of the sub-menu items can be selected by moving the cursor using the upward and downward direction buttons 31 or 34 and the select button 30. Note here that sub-menu item “help” can also be selected using the help button 61. With regard to the “Program” and “Setup” menus, the different analog and digital sub-menus can be displayed using the left and right direction buttons 32 and 33.

Since the sub-menu items of the “Program” and “Setup” menus for analog and digital modes are different from each other, the help function which explains the uses of the analog menu should be separated from that of the digital menu. In this case, however, since the sub-menu items of four main menus (i.e., Picture, Sound, Features, and Pip) are the same in both the analog and digital modes, it is inefficient for program size to separate the corresponding help functions. Accordingly, the preferred embodiment of the present invention suggests that the help functions should be included in each of the six main menus. By linking and managing the help function as module, such a configuration provides the advantage of reducing the program size and quickly providing the help function for the menu items which the user wants to know.

As described herein before, the method of OSD of the EPG, the integrated analog and digital menu, and the remote controller according to the preferred embodiment of the present invention have the following advantages. First, since the functional buttons of the remote controller are appropriately arranged according to the OSD screen, the user can manipulate the remote controller without an instruction manual. Second, by reducing the procedure of OSD, the user can select or set functions quickly. So it is easy to make good use of the OSD functions with a remote controller while watching television. Third, since the analog and digital menus are systemically integrated, the program size can be sufficiently reduced and more improved functions can be provided.

While the invention has been particularly shown and described with reference to the preferred embodiments thereof, it will be understood by those who skilled in the art that the foregoing and other changes in form and details may be made therein without departing from the spirit and scope of the invention.

What is claimed is:

1. A method of on-screen display (OSD), comprising the steps of:
displaying a channel banner on an upper and left side of television screen for a predetermined time period when a channel button of a remote controller is pressed while watching television, said channel banner disappearing when said predetermined time period ends;
displaying a program information banner on a lower portion of the television screen when an INFO button of said remote controller, instead of said channel button, is pressed while watching television; and
displaying an electronic program guide (EPG) that occupies the whole television screen when a GUIDE button of said remote controller is pressed while watching television.

2. The method as set forth in claim 1, further comprising the steps of:
displaying a detailed program information banner when said INFO button of said remote controller is pressed while said program information banner is displayed, said program information banner providing a display of program information including a current program's title and display time and a next program's title and display time according to a current channel, said detailed program information banner providing a display of detailed program information corresponding to a certain program selected while said program information banner was displayed;
displaying, in a rotational manner, program information according to favorite selected channels when a FAV button of said remote controller is pressed while said program information banner is displayed;
displaying program information according to a previous channel or next channel when an upward direction button of said remote controller and a downward direction button of said remote controller is pressed, respectively, while said program information banner is displayed; and
displaying program information according to the current channel for a previous time period or next time period when a left direction button of said remote controller and a right direction button of said remote controller is pressed, respectively, while said program information banner is displayed.

3. The method as set forth in claim 1, wherein said EPG comprises a listing of a plurality of categories and a grid displaying, by plural channels and plural time periods, a plurality of program titles, the steps of displaying an EPG further comprising the steps of:
moving a cursor in response to user activation of left, right, upward and downward direction buttons of said remote controller to highlight a particular program title or a particular category;
when the cursor is moved to a selected category and a CAT button of said remote controller is pressed, highlighting each program title in the grid corresponding to the selected category;
marking a program title as a favorite program title when the cursor is moved to a selected program title in said grid and a FAV button of said remote controller is pressed;
un-marking a program title as a favorite program title when the cursor is moved to a selected favorite program title in said grid and the FAV button of said remote controller is pressed; and
ending the on-screen display when an exit button of said remote controller is pressed.

4. The method as set forth in claim 2, wherein said EPG comprises a listing of a plurality of categories and a grid displaying, by plural channels and plural time periods, a plurality of program titles, the steps of displaying an EPG further comprising the steps of:
moving a cursor in response to a user pressing the left, right, upward and downward direction buttons of said remote controller to highlight a particular program title or a particular category;
when the cursor is moved to a selected category and a CAT button of said remote controller is pressed, highlighting each program title in the grid corresponding to the selected category;
marking a program title as a favorite program title when the cursor is moved to a selected program title in said grid and the FAV button of said remote controller is pressed;
un-marking a program title as a favorite program title when the cursor is moved to a selected favorite program title in said grid and the FAV button of said remote controller is pressed; and
ending the on-screen display when an exit button of said remote controller is pressed.

5. The method as set forth in claim 1, wherein said EPG comprises a listing of a plurality of categories and a grid displaying, by plural channels and plural time periods, a plurality of program titles, the steps of displaying an EPG further comprising the steps of:
scrolling said grid to display a plurality of program titles corresponding to a succeeding plurality of channels when a G button of the remote controller is pressed;
scrolling said grid to display a plurality of program titles corresponding to a preceding plurality of channels when an R button of the remote controller is pressed;
scrolling said grid to display a plurality of program titles corresponding to a succeeding plurality of time periods when a Y button of the remote controller is pressed; and
scrolling said grid to display a plurality of program titles corresponding to a preceding plurality of time periods when a B button of the remote controller is pressed.

6. The method as set forth in claim 3, the steps of displaying an EPG further comprising the steps of:
scrolling said grid to display a plurality of program titles corresponding to a succeeding plurality of channels when a G button of the remote controller is pressed;
scrolling said grid to display a plurality of program titles corresponding to a preceding plurality of channels when an R button of the remote controller is pressed;
scrolling said grid to display a plurality of program titles corresponding to a succeeding plurality of time periods when a Y button of the remote controller is pressed; and
scrolling said grid to display a plurality of program titles corresponding to a preceding plurality of time periods when a B button of the remote controller is pressed.

7. The method as set forth in claim 4, the steps of displaying an EPG further comprising the steps of:
scrolling said grid to display a plurality of program titles corresponding to a succeeding plurality of channels when a G button of the remote controller is pressed;
scrolling said grid to display a plurality of program titles corresponding to a preceding plurality of channels when an R button of the remote controller is pressed;
scrolling said grid to display a plurality of program titles corresponding to a succeeding plurality of time periods when a Y button of the remote controller is pressed; and
scrolling said grid to display a plurality of program titles corresponding to a preceding plurality of time periods when a B button of the remote controller is pressed.

8. The method as set forth in claim 1, further comprising the steps of:
integrating analog and digital menus such that a main menu is displayed when a menu button on the remote controller is pressed, said main menu comprising a first plurality of items each comprising corresponding separate analog and digital sub-menus and a second plurality of items each comprising corresponding common analog and digital sub-menus;
selecting one of said main menu items in response to user activation of upward and downward direction buttons of said remote controller; and
displaying a sub-menu of the selected main menu item in response to user activation of a select button of said remote controller.

9. The method as set forth in claim 8, the step of displaying a sub-menu further comprising the step of:
switching between the analog and digital sub-menus corresponding to said first plurality of items of said main menu in response to user activation of left and right direction buttons of said remote controller.

10. The method as set forth in claim 1, further comprising the step of:
displaying functions corresponding to home shopping, home banking or Internet access when an “i” button of the remote controller is pressed.

11. The method as set forth in claim 1, further comprising the step of:
displaying an e-mail function when a mail button of the remote controller is pressed.

12. A remote controller configured to correspond to a television on-screen display (OSD), a said remote controller comprising:
a channel button for selecting a channel to be viewed and for executing display of a channel banner, when pressed by a user while watching television, said channel banner including channel number information and broadcasting company information, said channel banner disappearing from display after a predetermined period of time;
an INFO button for executing display of a program information banner, when pressed by a user while watching television, said program information banner providing a display of program information including a current program's title and display time and a next program's title and display time according to a current channel;
a GUIDE button for executing display of an electronic program guide (EPG), when pressed by a user while watching television, said EPG providing a listing of a plurality of categories and a page laid out in a grid pattern, said grid pattern displaying information pertaining to a plurality of channels, a plurality of time periods and a plurality of program titles corresponding to the plurality of channels and time periods.

13. The remote controller as set forth in claim 12, further comprising:
said INFO button for executing display of a detailed program information banner, when pressed by a user, said detailed program information banner providing a display of detailed program information corresponding to a certain program selected while said program information banner was displayed;
a FAV button for executing display, in a rotational manner, program information according to favorite channels when pressed while said program information banner is displayed;
an upward direction button and a downward direction button for executing display of program information according to a previous channel or next channel, respectively, when is pressed while said program information banner is displayed; and
a left direction button and a right direction button for executing display of program information according to current channel for a previous time period or next time period, respectively, when is pressed while said program information banner is displayed.

14. The remote controller as set forth in claim 12, further comprising:
left, right, upward and downward direction buttons for executing movement of a cursor to highlight a particular program title or a particular category while said EPG is displayed;
a CAT button, when the cursor is moved to a selected category, activation of said CAT button causes each program title in the page corresponding to the selected category to be highlighted;
a FAV button causing a program title to be marked as a favorite program title when the cursor is moved to a selected program title in said page when pressed or causing a favorite program title to be un-marked when pressed; and
an exit button for causing the on-screen display to end, when pressed.

15. The remote controller as set forth in claim 13, further comprising:
said left, right, upward and downward direction buttons executing movement of a cursor to highlight a particular program title or a particular category while said EPG is displayed;
a CAT button, when the cursor is moved to a selected category, activation of said CAT button causes each program title in the page corresponding to the selected category to be highlighted;
a FAV button causing a program title to be marked as a favorite program title when the cursor is moved to a selected program title in said page when pressed or causing a favorite program title to be un-marked when pressed; and
an exit button for causing the on-screen display to end, when pressed.

16. The remote controller as set forth in claim 14, further comprising:
R, G, B and Y buttons for controlling red (R), green (G), blue (B) and yellow (Y) color of a displayed television program;
said G button executing scrolling of said page to display a plurality of program titles corresponding to a succeeding plurality of channels when pressed while said EPG is displayed;
said R button executing scrolling of said page to display a plurality of program titles corresponding to a preceding plurality of channels when pressed while said EPG is displayed;
said Y button executing scrolling of said page to display a plurality of program titles corresponding to a succeeding plurality of time periods when pressed while said EPG is displayed; and
said B button executing scrolling of said page to display a plurality of program titles corresponding to a preceding plurality of time periods when pressed while said EPG is displayed.

17. The remote controller as set forth in claim 12, further comprising a volume button for controlling volume.

18. The remote controller as set forth in claim 12, further comprising:
a menu button for executing display of a main menu comprised of integrated analog and digital menus when pressed, said main menu comprising a first plurality of items each comprising corresponding separate analog and digital sub-menus and a second plurality of items each comprising corresponding common analog and digital sub-menus;
upward and downward direction buttons for executing selection of one of said main menu items when pressed;
a select button for executing display of a sub-menu of the selected main menu item when pressed; and
left and right direction buttons for switching, when pressed, between the analog and digital sub-menus corresponding to said first plurality of items of said main menu.

19. The remote controller as set forth in claim 15, further comprising:
a menu button for executing display of a main menu comprised of integrated analog and digital menus when pressed, said main menu comprising a first plurality of items each comprising corresponding separate analog and digital sub-menus and a second plurality of items each comprising corresponding common analog and digital sub-menus;
said upward and downward direction buttons, when pressed while said main menu is displayed, executing selection of one of said main menu items;
a select button for executing display of a sub-menu of the selected main menu item when pressed; and
said left and right direction buttons, when pressed while said main menu is displayed, for switching between the analog and digital sub-menus corresponding to said first plurality of items of said main menu.

20. The remote controller as set forth in claim 12, further comprising:
an “i” button for executing display of functions corresponding to home shopping, home banking or Internet access when pressed; and
a mail button for executing display of an e-mail function when pressed.
